(19) United States
(12) Patent Application Publication
(10) Pub. No.: US 2015/0026259 A1
(43) Pub. Date: Jan. 22, 2015

(54) METHOD AND APPARATUS FOR PROVIDING COPING SERVICE BASED ON CONTEXT-AWARE INFORMATION

(71) Applicant: Electronics and Telecommunications Research Institute, Daejeon (KR)

(72) Inventors: Eunjin KO, Daejeon (KR); Sangwook PARK, Daejeon (KR); Mi Kyong HAN, Daejeon (KR); Jong Hyun JANG, Daejeon (KR)

(73) Assignee: Electronics and Telecommunications Research Institute, Daejeon (KR)

(21) Appl. No.: 14/169,908

(22) Filed: Jan. 31, 2014

(30) Foreign Application Priority Data
Jul. 18, 2013 (KR) 10-2013-0084883

(51) Int. Cl. H04L 29/06; H04L 29/08

(52) U.S. Cl. CPC H04L 63/302; H04L 67/10
USPC 709/204

(57) ABSTRACT

A method for providing a coping service based on context-aware information includes: recognizing a context through interworking with the devices provided in the space, and generating context-aware information; and searching for a service ID corresponding to the context-aware information from an awareness information and service mapping table in which awareness information occurrence time, occurrence place codes and service IDs are stored according to multiple awareness information IDs. Further, the method includes searching for workflow information corresponding to the searched service ID from a service workflow table in which workflow information according to service IDs is stored; and providing a service corresponding to the context awareness in accordance with the searched workflow.

### CROSS-REFERENCE TO RELATED APPLICATION(S)

The present invention claims priority to and the benefit of Korean Patent Application No. 10-2013-0084883, filed on Jul. 18, 2013, which is incorporated herein by reference in its entirety.

### FIELD OF THE INVENTION

The present invention relates to an apparatus and method for providing a context-aware information based coping service; and more particularly, to a method and apparatus for providing a coping service suitable for a context through a service mapping process with context-aware information.

### BACKGROUND OF THE INVENTION

Recently, as crimes against socially vulnerable classes in safety have increased, a safety information service using a mobile phone or the like has further activated, and a demand for the enhancement of a heinous criminal monitoring system has increased. However, the prevention of such crimes, an automated notification, and self-defense martial arts have no remarkable effect yet.

Especially, a method for predicting and preventing the occurrence of a dangerous situation or a criminal situation, with a technology of automatically recognizing and coping with the danger sensitivity of a potential victim and the crime sensitivity of a criminal in children or women-related crimes or kidnapping cases, which, recently, have been a social problem, is required. To this end, it is necessary to provide a service of automatically recognizing the danger sensitivity of a person and dangerous factors and preventing the occurrence of a dangerous situation or a criminal situation.

In order to provide such a prevention service, the conventional method is to simply map and provide a service with context information recognized according to preset mapping information, and the conventional service method is also performed such that a service is provided while it is checked only whether or not conditions preset in regular sequence are met.

However, when different services are provided according to the states of persons or devices existing in a place where service provision is required, and a service which performs a batch-process by taking multiple conditions determining a surrounding situation into consideration at the same time is provided, it is possible to provide a safer living environment. Accordingly, a service mapping technology dynamically considering a surrounding situation is required for providing an accurate service.

### SUMMARY OF THE INVENTION

In view of the above, the present invention provides a method and apparatus for providing a coping service based on context-aware information, which is able to simultaneously reflect and process multiple conditions determining a surrounding context when providing a safe living service through a service mapping process with context-aware information.

In accordance with a first aspect of the present invention, there is provided a method for providing a coping service based on context-aware information, which provides a corresponding service when a context is recognized through interworking with devices provided in a space. The method includes: recognizing a context through interworking with the devices provided in the space, and generating context-aware information; searching for a service ID corresponding to the context-aware information from an awareness information and service mapping table in which awareness information occurrence time, occurrence place codes and service IDs are stored according to multiple awareness information IDs; searching for workflow information corresponding to the searched service ID from a service workflow table in which workflow information according to service IDs is stored; and providing a service corresponding to the context awareness in accordance with the searched workflow.

Further, the searching of a service ID may be to search for a service ID which is identical to an awareness information ID, an awareness information occurrence time, and an awareness information occurrence place code of the context-aware information, from the awareness information and service mapping table.

Further, when a service ID which is identical to the awareness information ID, the awareness information occurrence time, and the awareness information occurrence place code of the context-aware information may not exist in the awareness information and service mapping table, the awareness information and service mapping table may be searched only with the awareness information ID of the context-aware information.

Further, the providing of the service may comprise reading, from the searched service workflow, a set of information which includes an operation code, an operation level, a device code, and an operation target ID, and then determining whether the set of information corresponds to an operation performed in advance; and providing an operation for a detailed service based on the operation code and device code when the set of information does not correspond to an operation performed in advance.

Further, the method may further comprise receiving a result of performance of the operation after the operation is provided; searching for an operation level in the workflow when the result of the performance of the operation is a failure; recording error contents according to the performance of the operation when the operation level is low; selecting an interworking-related person, who is to receive the error contents, from an interworking information table in which an interworking-related person ID, contact information, a terminal ID, and a target group ID are stored; and transmitting the error contents to the selected interworking-related person.

In accordance with a second aspect of the present invention, there is provided an apparatus for providing a coping service based on context-aware information. The apparatus includes: an context-aware unit configured to recognize a context through interworking with devices provided in a space, and generate context-aware information; an awareness information and service mapping table configured to store awareness information occurrence time, occurrence place codes and service IDs according to multiple awareness information IDs; a service workflow table configured to store workflow information for the respective service IDs; an awareness information and service mapping unit configured to search the awareness information and service mapping table with the context-aware information, and select a service ID suitable for the context; and a service workflow control unit configured to search the service workflow table for a workflow corresponding to the service ID, and then provide a coping service according to the context using the searched workflow.

Further, the apparatus may further comprise a unit operation table configured to interwork with the operation code and include an activity priority and a device code which are set for each of multiple operation codes is included. The workflow information may include an operation code, an operation level, a device code, an operation target ID, and a result of an operation, and the service workflow control unit may read an operation code, a level, a device code and an operation target ID, in regular sequence, corresponding to the selected service ID, searches the unit operation table based on the operation code and device code, provide an operation corresponding to a detailed service, and check whether the operation succeeds by comparing a result value with an operation result stored in the service workflow table after the operation is provided.

The apparatus may further comprise an interworking information table configured to interwork with an operation target ID in the service workflow table and store information on interworking-related persons according to multiple operation target IDs, and when a result of the operation is a failure, the service workflow control unit may check an operation level corresponding to the service ID, read information on an interworking-related person from the interworking information table on the basis of an operation target ID corresponding to the service ID when the operation level is equal to or higher than a preset value, and notify the interworking-related person of an error in operation performance.

Further, the awareness information and service mapping unit may search the awareness information and service mapping table for a service ID based on an awareness information occurrence time, a place, and an awareness information ID included in the context-aware information.

Further, the awareness information and service mapping unit may search the awareness information and service mapping table for a service ID with only an awareness information ID included in the context-aware information.

In accordance with an embodiment of the present invention, a proper service for coping with a dangerous context which may occur in a space, e.g. in a home is dynamically provided in consideration of peripheral devices or persons and the states of the devices, so that a safety service for safe life in the home can be provided within a required time period.

### BRIEF DESCRIPTION OF THE DRAWINGS

The objects and features of the present invention will become apparent from the following description of embodiments given in conjunction with the accompanying drawings, in which:

FIG. 1 is a block diagram illustrating the configuration of a system for providing a context-aware information based coping service in accordance with an embodiment of the present invention;

FIGS. 2A to 2F are views illustrating a virtual data structure of a terminal based on a user's living pattern in order to provide a coping service in accordance with the embodiment of the present invention; and

FIGS. 3 and 4 are flow charts illustrating a procedure of providing a coping service based on context-aware information in accordance with the embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, embodiments of the present invention will be described in detail with reference to the accompanying drawings which form a part hereof.

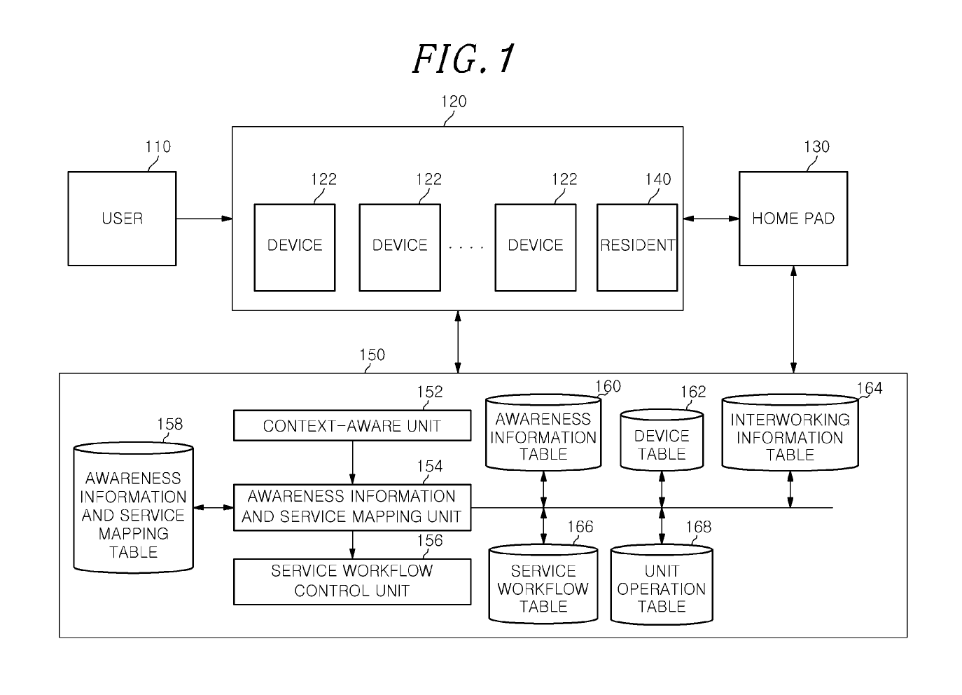

FIG. 1 is a block diagram illustrating the configuration of a system for providing a context-aware information based coping service according to one embodiment of the present invention.

The system for providing a context-aware information based coping service, shown in FIG. 1, may be configured such that a context begins and a coping service is provided when a user 110, e.g. an outsider or an invader, enters a specific space, e.g. a home 120. That is to say, when the user 110 presses a call number, devices (e.g. appliances) 122, such as sensors or the like in the home 120, corresponding to each context operate to notify a home pad 130 of entrance or exit of the user 110. When the user 110 invades, a device 122 such as a monitoring camera recognizes the invasion and informs the occurrence of the invasion through the home pad 130.

A resident 140, such as an old or feeble person or a child, in the home 120 can recognize the action state of a related device according to the type of operation of the device 122 in the home 120.

The device 122 in the home 120 may be an apparatus, such as a monitoring camera, a door lock, an object sensor, or the like, which can sense whether the user 110 enters or leaves the home, and whether the user 110 invades or not.

The home pad 130 may inform the home resident 140 whether the user 110 enters or leaves the home, and whether the user 110 invades or not in cooperation with the devices 122, for example, a personal mobile communication terminal, a tablet, or the like, in the home 120.

As illustrated in FIG. 1, an apparatus 150 for providing a context-aware information based coping service may be configured to include a context-aware unit 152, an awareness information and service mapping unit 154, a service workflow control unit 156, an awareness information and service mapping table 158, an awareness information table 160, a device table 162, an interworking information table 164, and a service workflow table 166.

The context-aware unit 152 collects information sensed by the devices 122 in the home 120, e.g. sensors provided in the home 120.

In addition, the context-aware unit 152 collects sensed information, processes context information currently occurring in the home 120 to produce context-aware information, and then transmits the context-aware information to the awareness information and service mapping unit 154. Here, the context-aware information may include an awareness information ID, an awareness information occurrence time, an awareness information occurrence place code, and the like.

The awareness information and service mapping unit 154 may select a coping service according to a context using awareness information and device information as supplementary information, by taking the context of the resident 140 in the home 120 and the devices 122 in the home 120 into consideration in the context occurrence place, on the basis of the context-aware information and the awareness information and service mapping table 158. In other words, the awareness information and service mapping unit 154 may select a service ID suitable for a context by searching the awareness information and service mapping table 158, based on context-aware information.

A method for allowing the awareness information and service mapping unit 154 to select a service ID will be described below.

First, if information identical with an awareness information ID, an awareness information occurrence time, and an awareness information occurrence place code in context-aware information exists in the awareness information and service mapping table 158, a corresponding service ID is selected; and if not, it is determined whether or not information identical with the awareness information ID in the context-aware information exists in the awareness information and service mapping table 158. That is to say, a service ID may be selected by searching the awareness information and service mapping table 158 using only the awareness information ID in the context-aware information.

A service ID selected through such a procedure may be provided to the service workflow control unit 156.

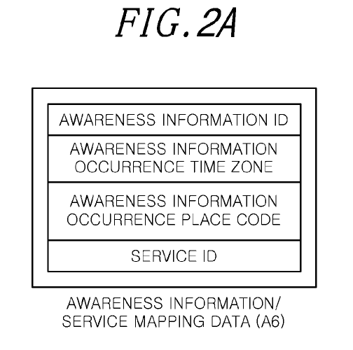

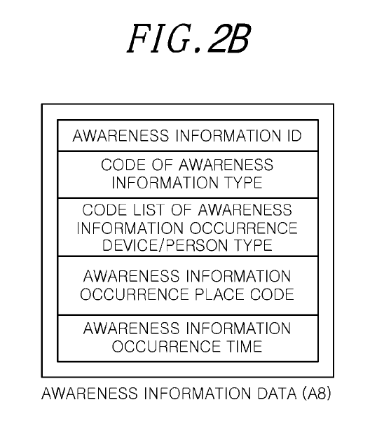

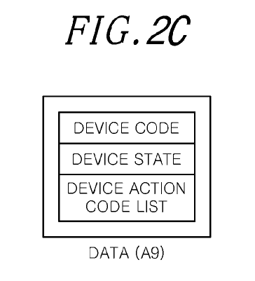

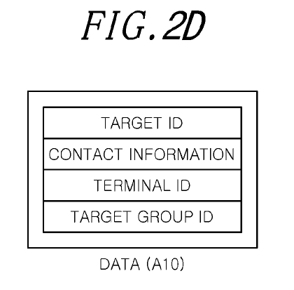

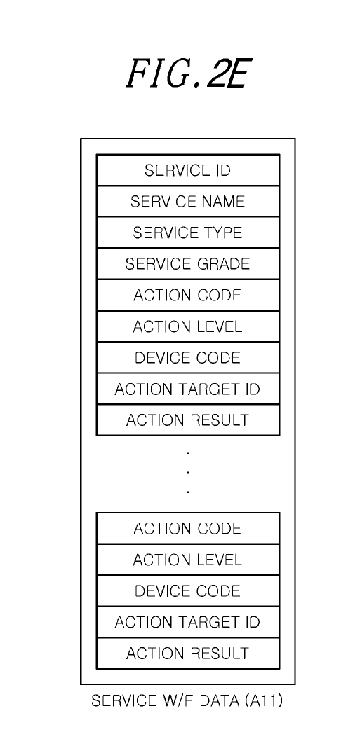

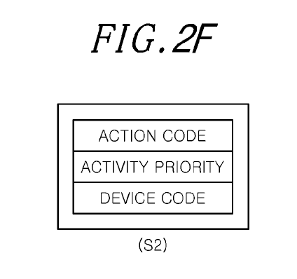

In the awareness information and service mapping table 158, as shown in FIG. 2A, awareness information occurrence time zones, awareness information occurrence place codes, service IDs, and the like according to awareness information IDs may be stored and managed.

On the basis of such information stored in the awareness information and service mapping table 158, a service ID corresponding to context-aware information can be selected.

In the awareness information table 160, as shown in FIG. 2B, an awareness information ID, an awareness information-type code, an awareness information occurrence appliance (device)/person-type code list, an awareness information occurrence place code, awareness information occurrence time information, and the like may be stored and managed. That is to say, the type of each context-aware information ID, an occurrence appliance (device) on a context occurrence, a person-type code, an occurrence place code, and occurrence time information may be stored in the awareness information table 160.

In the device table 162, as shown in FIG. 2C, a device code, a device state, a device operation code list, and the like may be stored and managed.

In the interworking information table 164, as shown in FIG. 2D, an interworking target ID, contact information, a terminal ID, a target group ID, and the like may be stored and managed. Such information in the interworking information table 164 may be used by the service workflow control unit 156 when an error occurs on provision of a coping service corresponding to a service ID. That is to say, when an error occurs, the service workflow control unit 156 may inform error contents on the basis of information stored in the interworking information table 164.

In the service workflow table 166, as shown in FIG. 2E, workflow information according to each service ID may be stored and managed. Here, the workflow information may include a service name, a type, a grade, an operation code, an operation level, an appliance code, an operation target ID, a result of an operation, and the like.

In the unit operation table 168, as shown in FIG. 2F, an activity priority corresponding to an operation code, an appliance code, and the like may be stored and managed. The unit operation table 168 may cooperate with an operation code included in workflow information.

The service workflow control unit 156 may select a workflow corresponding to a service ID from the service workflow table 166, in which workflow information required for driving a service has been stored, and may provide a corresponding service according to the selected workflow. On provision of a coping service, when an interworking-related device or an interworking-related person exists, a service may be provided with information stored in the interworking information table 164.

In addition, the service workflow control unit 156 may search the unit operation table 168 using an operation code and a device code corresponding to a selected service ID, and provide an operation corresponding to a detailed service. Also, when receiving a result value of the provided operation, the service workflow control unit 156 may check whether or not the operation succeeds through a comparison between the operation result value of a service ID and the received result value.

Meanwhile, when the result of an operation is a failure, the service workflow control unit 156 may transmit failure-related data, i.e. error information, to the interworking-related person on the basis of information stored in the interworking information table 164.

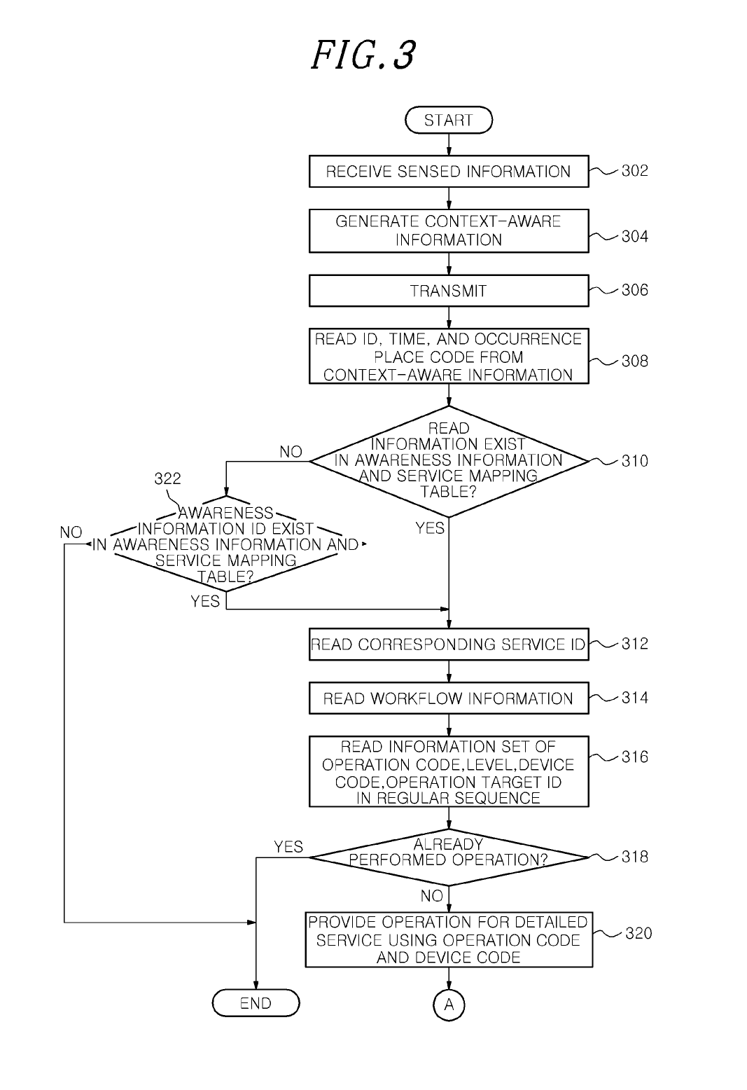

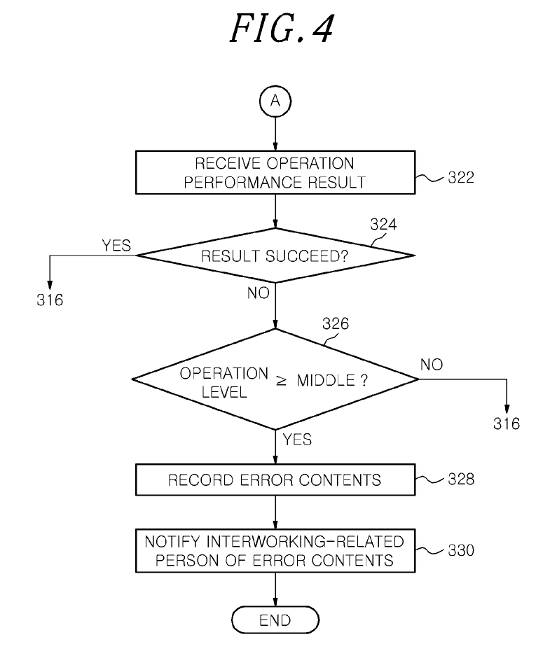

A procedure in which the apparatus 150 for providing a context-aware information based coping service, configured as above, provides a service will be described with reference to FIGS. 3 and 4.

FIGS. 3 and 4 are flow charts illustrating a procedure of providing a context-aware information based coping service according to one embodiment of the present invention.

As shown in FIG. 3, the context-aware unit 152 receives information sensed by various devices 122, such as a sensor in the home 120, and the like, in operation 302.

The context-aware unit 152 generates context-aware information on the basis of the sensed information, which has been received, in operation 304, and transmits the generated context-aware information to the awareness information and service mapping unit 154 in operation 306. Here, the context-aware information may include an awareness information ID, an awareness information occurrence time, an occurrence place code, and the like.

The awareness information and service mapping unit 154 reads the awareness information ID, the occurrence time, the occurrence place code from the context-aware information in operation 308, and then determines whether or not the read information exists in the awareness information and service mapping table 158 in operation 310.

When it is determined that a service ID corresponding to the awareness information ID, the occurrence time, the occurrence place code exists as a result of the determination of step 310, the awareness information and service mapping unit 154 reads a service ID from the awareness information and service mapping table 158 in operation 312, and then provides the read service ID to the service workflow control unit 156.

When receiving the service ID, the service workflow control unit 156 reads information corresponding to the service ID from the service workflow table 166 in operation 314. That is to say, the service workflow control unit 156 reads information on a service name, a type, a grade, an operation code, an operation level, an appliance code, an operation target ID, an operation result, and the like, which correspond to the service ID.

Then, the service workflow control unit 156 reads a set of information, which includes the operation code, the operation level, the appliance code, the operation target ID, and the like, in regular sequence from the read information in operation 316.

In step 318, the service workflow control unit 156 determines whether or not the information read in operation 316 is already-performed information, i.e. an operation performed in advance.

If it is determined that the information read in operation 316 is an operation performed in advance as a result of the determination of step 318, the service workflow control unit 156 ends a corresponding service workflow because the corresponding service workflow has been performed, and if not, the service workflow control unit 156 provides a detailed operation for a service using information on an operation code and an appliance code in operation 320.

Then, as shown in FIG. 4, the service workflow control unit 156 receives a result of an operation performance in operation 322, and determines whether or not the operation succeeds in operation 324.

If it is determined that the operation performance succeeds as a result of the determination of step 324, the service workflow control unit 156 proceeds to step 316 to read next operation information and to perform following steps; and if not, the service workflow control unit 156 determines whether or not an operation level is equal to or higher than a middle level in operation 326.

When it is determined that the operation level is equal to or higher than the middle level as a result of determination of step 326, which corresponds to a serious error, the service workflow control unit 156 records contents corresponding to the error in operation 328. Then, the service workflow control unit 156 reads information on an interworking-related person from the interworking information table 164, notifies the interworking-related person of error contents in the operation performance in operation 330, and terminates the procedure.

When if it is determined that the operation level corresponds to a low level as a result of step 326, which means that the importance of a corresponding action is low, the following operation is performed.

Meanwhile, it is determined that a service ID corresponding to the awareness information ID, the awareness information occurrence time, the occurrence place code does not exist in the service workflow table 166 as a result of the determination of step 310, the awareness information and service mapping unit 154 determines whether or not a service ID corresponding to the awareness information ID exists in the awareness information and service mapping table 158 in operation 332.

If it is determined that a service ID corresponding to the awareness information ID exists in the awareness information and service mapping table 158 as a result of step 332, the procedure proceeds to step 312 so that a following step can be performed; and if not, the procedure is terminated because there is no service to be provided.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for providing a coping service based on context-aware information, which provides a corresponding service when a context is recognized through interworking with devices provided in a space, the method comprising:
recognizing a context through interworking with the devices provided in the space, and generating context-aware information;
searching for a service ID corresponding to the context-aware information from an awareness information and service mapping table in which awareness information occurrence time, occurrence place codes and service IDs are stored according to multiple awareness information IDs;
searching for workflow information corresponding to the searched service ID from a service workflow table in which workflow information according to service IDs is stored; and
providing a service corresponding to the context awareness in accordance with the searched workflow.

2. The method of claim 1, wherein the searching of a service ID is to search for a service ID which is identical to an awareness information ID, an awareness information occurrence time, and an awareness information occurrence place code of the context-aware information, from the awareness information and service mapping table.

3. The method of claim 2, wherein, when a service ID which is identical to the awareness information ID, the awareness information occurrence time, and the awareness information occurrence place code of the context-aware information does not exist in the awareness information and service mapping table, the awareness information and service mapping table is searched only with the awareness information ID of the context-aware information.

4. The method of claim 1, wherein the providing of the service comprises:
reading, from the searched service workflow, a set of information which includes an operation code, an operation level, a device code, and an operation target ID, and then determining whether the set of information corresponds to an operation performed in advance; and
providing an operation for a detailed service based on the operation code and device code when the set of information does not correspond to an operation performed in advance.

5. The method of claim 4, further comprising:
receiving a result of performance of the operation after the operation is provided;
searching for an operation level in the workflow when the result of the performance of the operation is a failure;
recording error contents according to the performance of the operation when the operation level is low;
selecting an interworking-related person, who is to receive the error contents, from an interworking information table in which an interworking-related person ID, contact information, a terminal ID, and a target group ID are stored; and
transmitting the error contents to the selected interworking-related person.

6. An apparatus for providing a coping service based on context-aware information, comprising:
an context-aware unit configured to recognize a context through interworking with devices provided in a space, and generate context-aware information;
an awareness information and service mapping table configured to store awareness information occurrence time, occurrence place codes and service IDs according to multiple awareness information IDs;
a service workflow table configured to store workflow information for the respective service IDs;
an awareness information and service mapping unit configured to search the awareness information and service mapping table with the context-aware information, and select a service ID suitable for the context; and
a service workflow control unit configured to search the service workflow table for a workflow corresponding to the service ID, and then provide a coping service according to the context using the searched workflow.

7. The apparatus of claim 6, further comprising a unit operation table configured to interwork with the operation code and include an activity priority and a device code which are set for each of multiple operation codes is included,
wherein the workflow information includes an operation code, an operation level, a device code, an operation target ID, and a result of an operation, and
wherein the service workflow control unit reads an operation code, a level, a device code and an operation target ID, in regular sequence, corresponding to the selected service ID, searches the unit operation table based on the operation code and device code, provides an operation corresponding to a detailed service, and checks whether the operation succeeds by comparing a result value with an operation result stored in the service workflow table after the operation is provided.

8. The apparatus of claim 7, further comprising an interworking information table configured to interwork with an operation target ID in the service workflow table and store information on interworking-related persons according to multiple operation target IDs,
wherein, when a result of the operation is a failure, the service workflow control unit checks an operation level corresponding to the service ID, reads information on an interworking-related person from the interworking information table on the basis of an operation target ID corresponding to the service ID when the operation level is equal to or higher than a preset value, and notifies the interworking-related person of an error in operation performance.

9. The apparatus of claim 6, wherein the awareness information and service mapping unit searches the awareness information and service mapping table for a service ID based on an awareness information occurrence time, a place, and an awareness information ID included in the context-aware information.

10. The apparatus of claim 6, wherein the awareness information and service mapping unit searches the awareness information and service mapping table for a service ID with only an awareness information ID included in the context-aware information.
